(19) United States
(12) Patent Application Publication
(10) Pub. No.: US 2003/0080656 A1
(43) Pub. Date: May 1, 2003

(54) Combinational shelf

(76) Inventor: Shun-Teng Chen, Taichung (TW)

Correspondence Address: Shun-Teng Chen, 58 MA YUAN WEST ST., TAICHUNG, TW

(21) Appl. No.: 10/002,990

(22) Filed: Oct. 26, 2001

(51) Int. Cl. E06B 9/15

(52) U.S. Cl. 312/297

(57) ABSTRACT

A combinational shelf has a top plate, a base plate, a rear plate, a first lateral plate, a second lateral plate, a roll-up door, and a front frame. The first lateral plate and the second lateral plate are disposed on the base plate. The rear plate is disposed between the first lateral plate and the second lateral plate. The top plate is disposed on the rear plate, the first lateral plate, and the second lateral plate. The top plate has a front panel. The base plate has a front bar and a plurality of sockets. The first lateral plate has a plurality of first bottom plugs, a plurality of positioning bars, a U-shaped rail, and a front groove communicating with the U-shaped rail. The second lateral plate has a plurality of second bottom plugs. The front frame has an inner flange. The first bottom plugs and the second bottom plugs are inserted in the sockets of the base plate. The roll-up door engages with the U-shaped rail.

### BACKGROUND OF THE INVENTION

The present invention relates to a combinational shelf. More particularly, the present invention relates to a combinational shelf which has a special roll-up door.

Referring to FIGS. 1 and 1A, a conventional shelf has a top plate A, a base plate B, a rear plate F, a first lateral plate C, a second lateral plate D, and a roll-up door I. The first lateral plate C has a periphery frame G having a U-shaped rail H to receive the roll-up door I. The first lateral plate C and the second lateral plate D are disposed on the base plate B. The rear plate F is disposed between the first lateral plate C and the second lateral plate D. The top plate A is disposed on the rear plate F, the first lateral plate C, and the second lateral plate D. The U-shaped rail H has a guide notch J. The roll-up door I is inserted in the U-shaped rail H through the guide notch J of the U-shaped rail H. However, the roll-up door I may slide out of the guide notch J of the U-shaped rail H. The roll-up door I is made of a plurality of plastics plates. Therefore, it is difficult to manufacture the roll-up door I.

### SUMMARY OF THE INVENTION

An object of the present invention is to provide a combinational shelf which has a front frame to block a roll-up door.

Another object of the present invention is to provide a combinational shelf which has a roll-up door made of plastics material and the roll-up door has a plurality of cross bars and a plurality of notches so that the roll-up door is flexible.

Accordingly, a combinational shelf comprises a top plate, a base plate, a rear plate, a first lateral plate, a second lateral plate, a roll-up door, and a front frame. The first lateral plate and the second lateral plate are disposed on the base plate. The rear plate is disposed between the first lateral plate and the second lateral plate. The top plate is disposed on the rear plate, the first lateral plate, and the second lateral plate. The top plate has a front panel. The base plate has a front bar and a plurality of sockets. The first lateral plate has a plurality of first bottom plugs, a plurality of positioning bars, a U-shaped rail, and a front groove communicating with the U-shaped rail. The second lateral plate has a plurality of second bottom plugs. The front frame has an inner flange. The first bottom plugs and the second bottom plugs are inserted in the sockets of the base plate. The roll-up door engages with the U-shaped rail through the front groove of the first lateral plate. The inner flange of the front frame blocks the front groove of the first lateral plate.

### BRIEF DESCRIPTION OF THE DRAWINGS

FIG. 1 is a perspective exploded view of a conventional shelf of the prior art;

FIG. 1A is a partially perspective enlarged view of a first lateral plate of the prior art;

FIG. 2 is a perspective exploded view of a combinational shelf of a preferred embodiment in accordance with the present invention;

FIG. 3 is a perspective assembly view of a combinational shelf without a front frame and a roll-up door;

FIG. 4 is a perspective assembly view of a combinational shelf without a front frame;

FIG. 5 is a perspective assembly view of a combinational shelf of a preferred embodiment in accordance with the present invention;

FIG. 6 is a sectional view of a first lateral plate of a preferred embodiment while the first lateral plate is assembled; and

FIG. 7 is a sectional schematic view of a roll-up door of a preferred embodiment in accordance with the present invention.

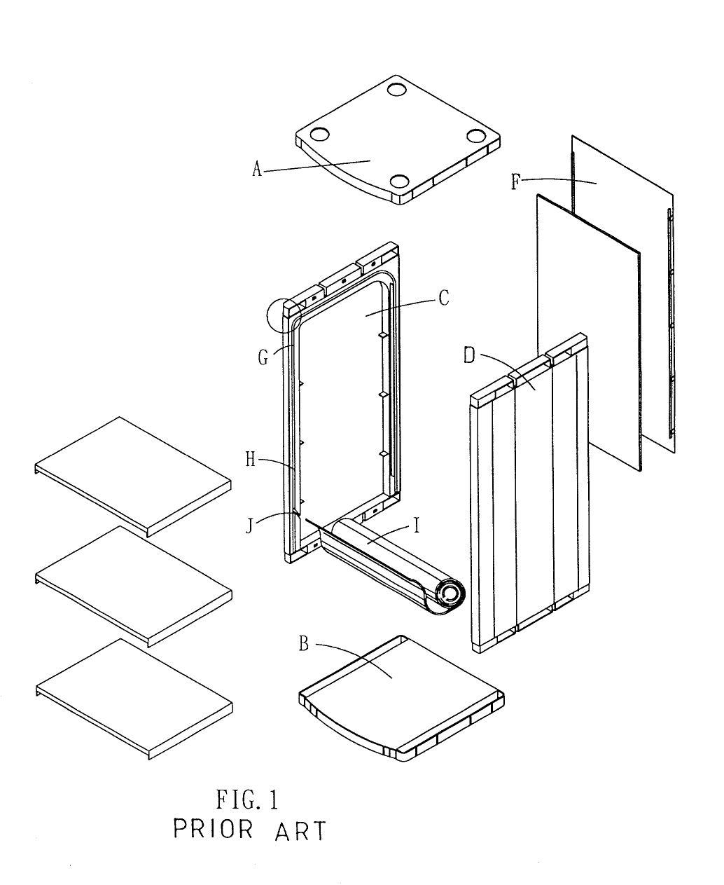

### DETAILED DESCRIPTION OF THE INVENTION

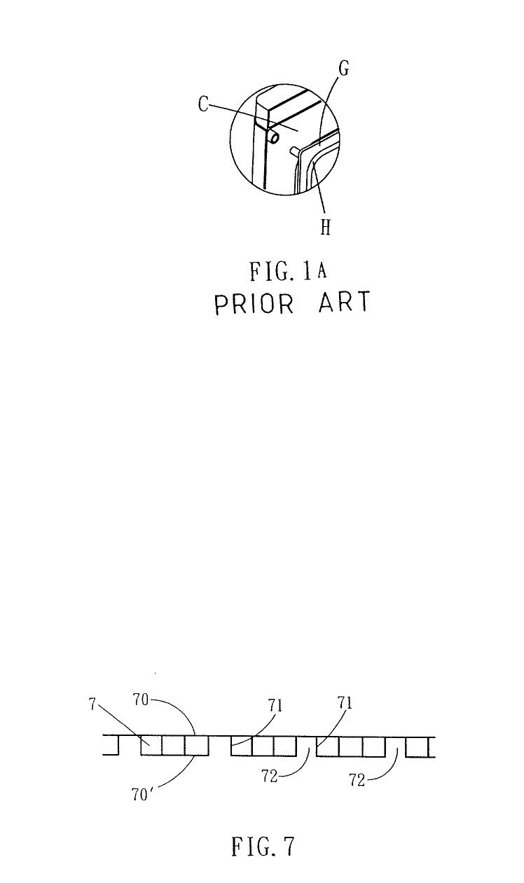

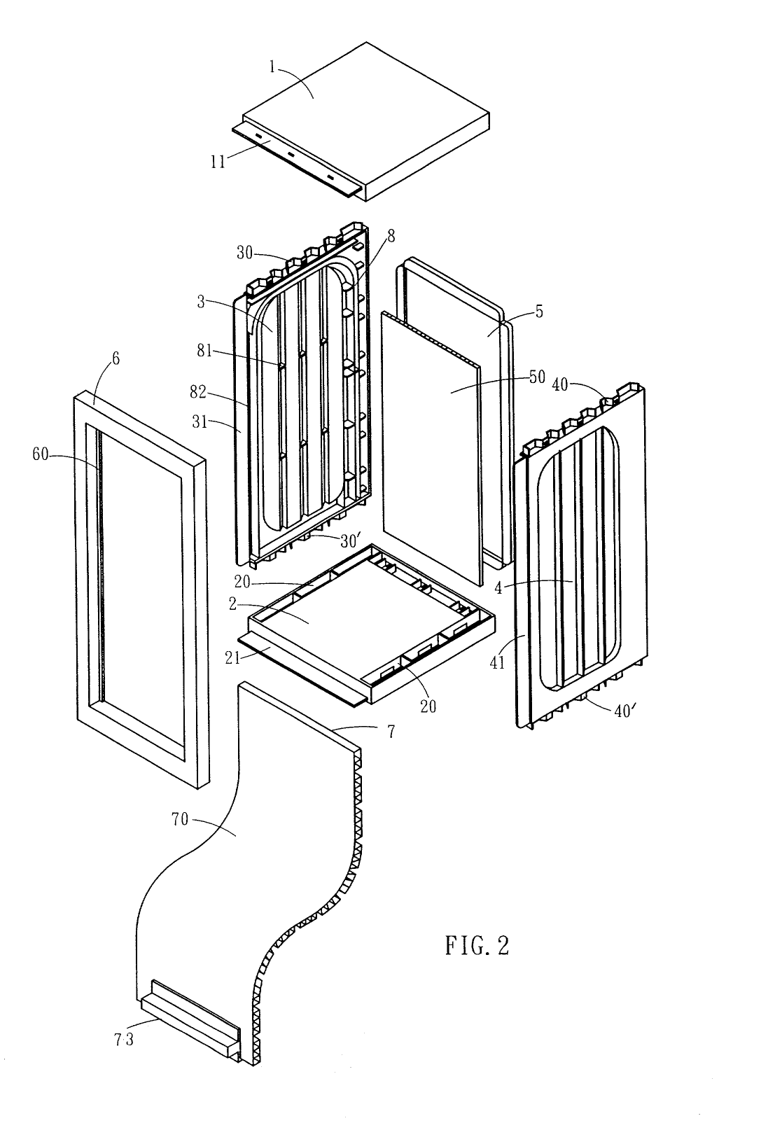

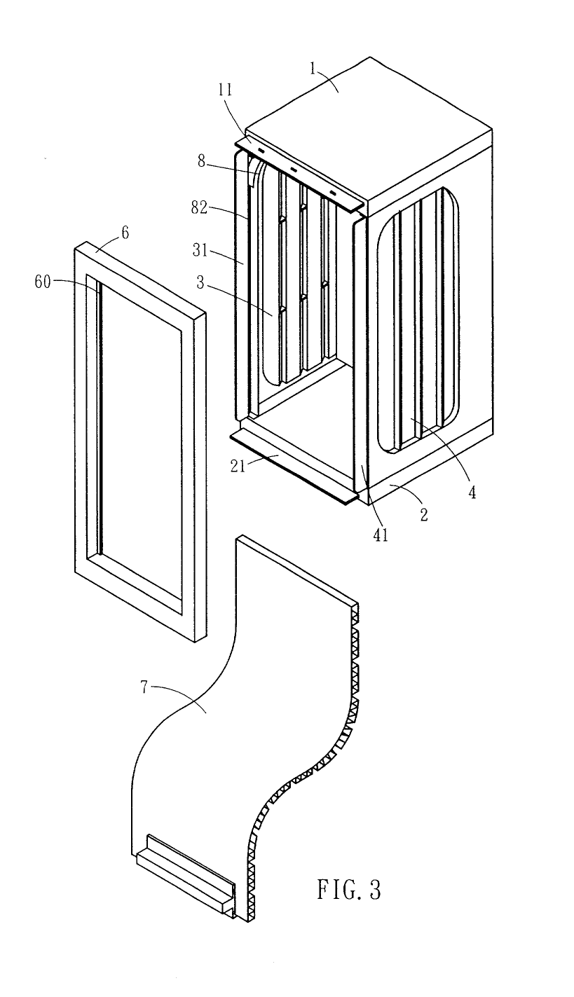

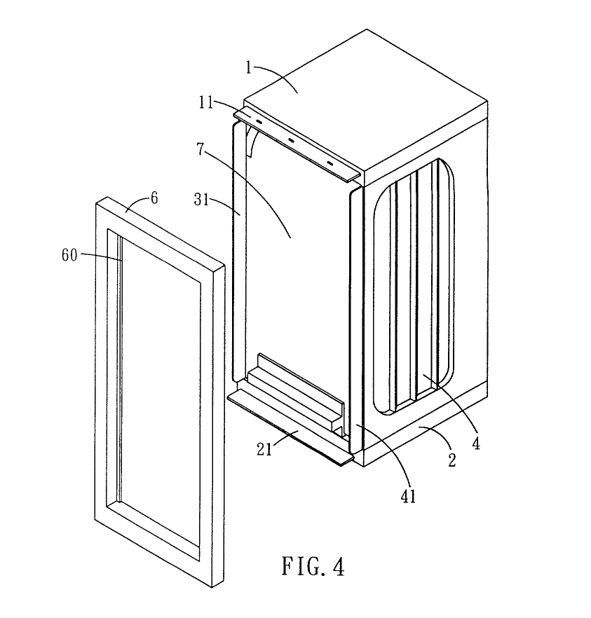

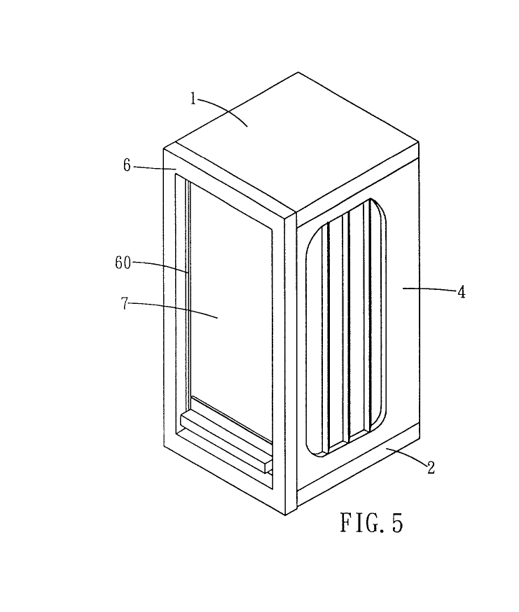

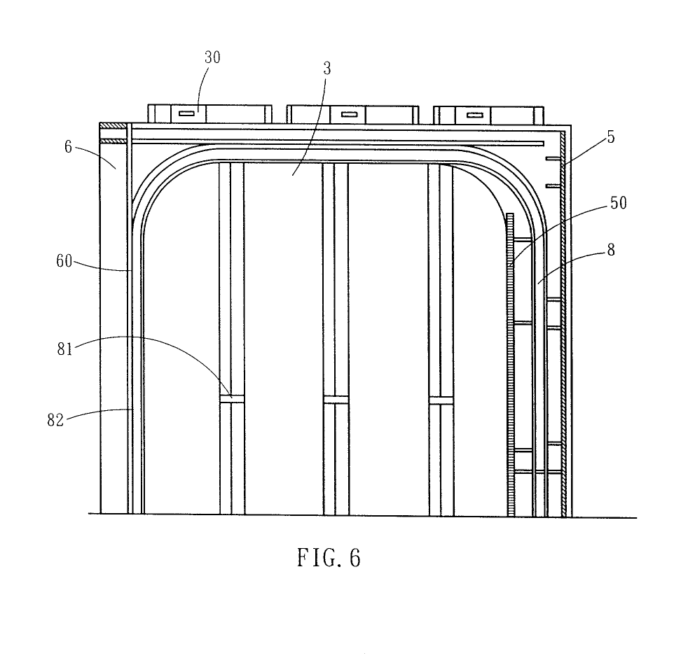

Referring to FIGS. 2 to 7, a combinational shelf comprises a top plate 1, a base plate 2, a rear plate 5, a first lateral plate 3, a second lateral plate 4, a roll-up door 7, and a front frame 6.

The first lateral plate 3 and the second lateral plate 4 are disposed on the base plate 2.

The rear plate 5 is disposed between the first lateral plate 3 and the second lateral plate 4.

The top plate 1 is disposed on the rear plate 5, the first lateral plate 3, and the second lateral plate 4.

The top plate 1 has a front panel 11.

The base plate 2 has a front bar 21 and a plurality of sockets 20.

The first lateral plate 3 has a plurality of first top plugs 30, a plurality of first bottom plugs 30′, a plurality of positioning bars 81, a U-shaped rail 8, and a front groove 82 communicating with the U-shaped rail 8.

The second lateral plate 4 has a plurality of second top plugs 40 and a plurality of second bottom plugs 401.

The front frame 6 has an inner flange 60.

The first bottom plugs 30′ and the second bottom plugs 40′ are inserted in the sockets 20 of the base plate 2.

The roll-up door 7 engages with the U-shaped rail 8 through the front groove 82 of the first lateral plate 3.

The inner flange 60 of the front frame 6 blocks the front groove 82 of the first lateral plate 3.

The roll-up door 7 has a front layer 70, a lower handle 73 disposed on the front layer 70, a plurality of cross bars 70′ having a plurality of ribs 71, and a plurality of notches 72.

The first lateral plate 3 further has a first front plate 31.

The second lateral plate 4 further has a second front plate 41.

The front panel 11, the base plate 2, the first front plate 31, and the second front plate 41 are inserted in the front frame 6.

A separation plate 50 is disposed in the combinational shelf.

The invention is not limited to the above embodiment but various modification thereof may be made. Further, various changes in form and detail may be made without departing from the scope of the invention.

I claim:

1. A combinational shelf comprises:
a top plate, a base plate, a rear plate, a first lateral plate, a second lateral plate, a roll-up door, and a front frame,
the first lateral plate and the second lateral plate disposed on the base plate,
the rear plate disposed between the first lateral plate and the second lateral plate,
the top plate disposed on the rear plate, the first lateral plate, and the second lateral plate,
the top plate having a front panel,
the base plate having a front bar and a plurality of sockets,
the first lateral plate having a plurality of first bottom plugs, a plurality of positioning bars, a U-shaped rail, and a front groove communicating with the U-shaped rail,
the second lateral plate having a plurality of second bottom plugs,
the front frame having an inner flange,
the first bottom plugs and the second bottom plugs inserted in the sockets of the base plate,
the roll-up door engaging with the U-shaped rail through the front groove of the first lateral plate, and
the inner flange of the front frame blocking the front groove of the first lateral plate.

2. The combinational shelf as claimed in claim 1, wherein the roll-up door has a front layer, a lower handle disposed on the front layer, a plurality of cross bars having a plurality of ribs, and a plurality of notches.
